(19) United States
(12) Patent Application Publication
(10) Pub. No.: US 2017/0120229 A1
(43) Pub. Date: May 4, 2017

(54) ACTIVE PHASE BIMODAL COMMIXED CATALYST, PROCESS FOR ITS PREPARATION AND USE IN HYDROTREATING RESIDUE

(71) Applicant: IFP Energies Nouvelles, Rueil-Malmaison Cedex (FR)

(72) Inventors: Malika BOUALLEG, Villeurbanne (FR); Bertrand GUICHARD, Izeaux (FR)

(73) Assignee: IFP Energies Nouvelles, Rueil-Malmaison Cedex (FR)

(21) Appl. No.: 15/318,561

(22) PCT Filed: Jun. 9, 2015
(86) PCT No.: PCT/EP2015/062822

§ 371 Date: Dec. 13, 2016

(30) Foreign Application Priority Data
Jun. 13, 2014 (FR) 1455416

(51) Int. Cl. B01J 27/19; C10G 65/04; B01J 21/04; B01J 37/04; B01J 37/03; B01J 37/00; B01J 37/02; B01J 37/08; C10G 45/08; B01J 35/10

(52) U.S. Cl. CPC B01J 27/19; C10G 45/08; C10G 65/04; B01J 21/04; B01J 35/1019; B01J 35/1023; B01J 35/1028; B01J 35/1061; B01J 35/1071; B01J 35/1076; B01J 35/1042; B01J 35/1047; B01J 37/031; B01J 37/009; B01J 37/0236; B01J 37/08; B01J 37/04; C10G 2300/107; C10G 2300/1077; C10G 2300/202; C10G 2300/205

(57) ABSTRACT

A hydroconversion catalyst with a bimodal pore structure:
an oxide matrix predominantly of calcined aluminium;
a hydro-dehydrogenative active phase of at least one group VIII metal being at least partly commixed within the said oxide matrix mainly made up of calcined aluminium, an S_{BET} specific surface greater than 100 m²/g, a mesoporous median diameter in volume between 12 and 25 nm inclusive, a macroporous median diameter in volume between 250 and 1500 nm inclusive, a mesoporous volume as measured by mercury intrusion porosimeter greater than or equal to 0.55 ml/g and a total measured pore volume by mercury porosimetry greater than or equal to 0.70 ml/g;
   a method for preparing a residue catalyst for hydroconversion/hydroprocessing by commixing the active phase with a particular alumina,
   the use of the catalyst in hydroproces sing, including hydroproces sing heavy feeds.

### TECHNICAL FIELD OF THE INVENTION

This invention relates to hydrotreating catalysts, in particular residues, and concerns preparing the active commixing phase of hydrotreating catalysts having a favourable texture and formulation for the hydrotreating of residue, particularly for hydrodemetalation. The preparation process, according to the invention, allows avoiding the impregnation step usually carried out on a previously shaped support medium.

The invention uses catalysts made up of at least one aluminium oxide matrix, at least one element of the VI B group, and possibly at least one element of group VIII and possibly phosphorus. Introducing this type of active phase before the commixing shaping step with a particular alumina, which itself stems from calcining a specific gel, unexpectedly allows—under the hydrotreating processes, particularly for residues in a fixed bed, but also in an ebullated bed process—a significant improvement in the hydrodesulphurisation activity as well as the hydrodemetalation of the catalyst, while significantly reducing manufacturing costs.

### PRIOR ART

It is known to the person skilled in the art that catalytic hydrotreating allows bringing into contact a hydrocarbon feed with a catalyst whose properties in terms of active phase metals and porosity have previously been correctly adjusted, to substantially reduce its asphaltene, metal, and sulphur content as well as other impurities and improve the hydrogen to carbon ratio (H/C) while transforming it to a greater or lesser extent into lighter cuts.

Hydrotreating fixed bed residue processes (commonly called a “Residue Desulphurisation” unit or RDS) leads to better refining results; typically it is used to produce a boiling temperature of 370° C. containing less than 0.5% sulphur by weight and less than 20 ppm of metals, from feeds containing up to 5% of sulphur by weight and up to 250 ppm of metals (Ni+V). The various effluents thus obtained can serve as a basis for the production of good quality heavy fuel oil and/or pre-treated feedstock for other units such as Fluid Catalytic Cracking. In contrast, the hydroconversion of the residue of cuts lighter than atmospheric residue, as in diesel and petrol, is generally low, typically around 10-20% by weight. In such a process, the feed is pre-mixed with hydrogen and flows through several fixed-bed reactors arranged in series and filled with catalysts. The total pressure is typically between 100 and 200 bars with temperatures between 340 and 420° C. The effluents withdrawn from the last reactor are sent to a stripping section.

Conventionally, the fixed-bed hydrotreating process involves at least two steps (or sections). The first step, known as hydrodemetalation (HDM), is primarily intended to remove most of the metal in the feed using one or more hydrodemetalation catalysts. This step primarily consists of eliminating the vanadium, nickel and to a lesser extent the iron.

The second step or section is called hydrodesulphurisation (HDS), which involves passing the product of the first step into one or more hydrodesulphurisation catalysts that are more active in terms of hydrodesulphurisation and hydrogenation of the feed, but less tolerant to metals.

If the metal content of the feed is too high (more than 250 ppm) and/or if a high conversion is sought (conversion of the heavy fraction 540° C.+ (or 370° C.+) into a lighter fraction 540° C.− (or 370° C.−) is sought, then hydrotreating processes in an ebullated bed are preferable. For this type of process (see M S Rana et al. Fuel 86 (2007), p. 1216), the purification result is less than with the RDS process, but the hydroconversion of the residue fraction is high, of the order of 45-85% volume. The high temperatures, between 415° C. and 440° C., contribute to this high hydroconversion. Thermal cracking reactions are favoured, because in general the catalyst does not have a specific hydroconversion function. Moreover, the effluents formed by this type of conversion may have stability issues due to sediment formation.

Therefore, when hydrotreating residues, developing versatile, powerful and stable catalysts is essential.

For ebullated bed processes, we learn from patent application WO 2010/002699 that it is advantageous to use a catalyst whose support medium has a median pore diameter of between 10 and 14 nm with a narrow distribution. It specifies that less than 5% of the porous mass may have pores greater than 21 nm and also that less than 10% of the volume should contain small pores of less than 9 nm. U.S. Pat. No. 5,968,348 confirms that it is preferable to use a support medium whose mesoporosity remains around 11 to 13 nm, with the possible presence of macropores and a high BET surface area.

For fixed-bed processes, U.S. Pat. No. 6,780,817 provides that it is necessary to use a catalyst support medium that comprises at least 0.32 ml/g of macroporous volume for stable fixed bed operation. This kind of catalyst also has a median diameter in the mesopores of 8 to 13 nm and a high specific surface area of at least 180 m²/g.

U.S. Pat. No. 6,919,294 also describes the use of a so-called bimodal support medium, which is both mesoporous and macroporous, using heavy macroporous volumes, but with mesoporous volume limited to 0.4 ml/g at the most.

U.S. Pat. Nos. 4,976,848 and 5,089,463 describe a hydrodemetalation and hydrodesulphurisation catalyst comprising a hydrogenating active phase using metals of groups VI and VIII, and an inorganic refractory oxide support medium; the catalyst having precisely between 5 and 11% of its pore volume in the form of macropores, mesopores of a median diameter greater than 16.5 nm, and being used in an hydrodemetalation and hydrodesulphurisation process for heavy feeds.

U.S. Pat. No. 7,169,294 describes a hydroconversion catalyst for heavy feeds consisting of between 7 and 20% of Group VI metal and between 0.5 and 6% by weight of metal from group VIII on an aluminium support medium. The catalyst has a specific surface of between 100 and 180 m²/g, a total pore volume greater than or equal to 0.55 ml/g, at least 50% of the total pore volume consisting of pores greater than 20 nm, at least 5% of the total pore volume consisting of pores greater than 100 nm, at least 85% of the total pore volume being of pores between 10 and 120 nm, less than 2% of the total pore volume being of pores with diameters greater than 400 nm, and less than 1% of the total pore volume being of pores with a diameter greater than 1,000 nm.

Numerous developments relate, in particular, to the optimisation of the pore distribution of the catalyst or catalyst combination by improving the catalyst support medium.

Thus, U.S. Pat. No. 6,589,908, for example, describes a process for preparing an alumina characterised by a lack of macropores, less than 5% of the total pore volume consisting of pore diameters greater than 35 nm, a high pore volume of over 0.8 ml/g and a bimodal mesopore distribution in which the two modes are separated by 1 to 20 nm and where the primary pore mode is larger than the median pore diameter. To this end, the preparation method described uses two steps of alumina precursor precipitation under well-controlled temperature, pH and flow conditions. The first step is run at a temperature between 25 and 60° C. with a pH of between 3 and 10. The suspension is then heated to a temperature between 50 and 90° C. Reagents are again added to the suspension, which is then washed, dried, shaped and calcined to form a catalyst support medium. This support medium is then impregnated with an active phase solution to obtain a hydrotreating catalyst; a residue hydrotreating catalyst is described on a monomodal mesoporous support medium with a median pore diameter of around 20 nm.

Patent application WO 2004/052534 A1 describes using hydrocarbon feeds in hydrotreating that are heavy with a mixture of two catalysts with support mediums having different porous characteristics; the first catalyst having more than half of its pore volume in diameters greater than 20 nm, 10 to 30% of the pore volume in diameters greater than 200 nm, the total pore volume being greater than 0.55 ml/g, the second having more than 75% pore volume with diameters between 10 and 120 nm, less than 2% in pores of diameter greater than 400 nm and 0 to 1% in pores of diameter greater than 1000 nm. The preparation process described to prepare these catalysts includes a step for co-precipitating aluminium sulphate with sodium aluminate; the gel obtained is then dried, extruded and calcined. It is possible to add silica during or after the co-precipitation. Adjusting the shape allows obtaining the characteristics of the support medium.

Group VIB, VII, IA and V metals can be incorporated into the support medium by impregnating and/or incorporating them into the support medium before shaping it into particles. Impregnation is preferred.

U.S. Pat. No. 7,790,652 describes hydroconversion catalysts obtainable by co-precipitation of an alumina gel, and then putting the metals on the support medium obtained by any well-known method, particularly by impregnation. The resulting catalyst has a monomodal distribution with a mesoporous median diameter of between 11 and 12.6 nm and a pore distribution size of less than 3.3 nm.

Alternative approaches to the conventional introduction of metals onto aluminium support mediums have also been developed such as the incorporation of catalyst fines in the support medium. Thus, the application for patent WO 2012/021386 describes hydroprocessing catalysts that include a refractory pore oxide support medium shaped from alumina powder and 5% to 45% by weight of catalyst fines. The support medium including the fines is then dried and calcined. The support medium obtained has a specific surface area of between 50 m²/g and 450 m²g, a median pore diameter of between 50 and 200 A, and a total pore volume exceeding 0.55 cm³/g. The support medium thus consists of embedded metal, due to the metal in the catalyst fines. The resulting support medium can be treated using a chelating agent. The pore volume can be partially filled using a polar additive, then impregnated by a metal impregnation solution.

In the light of prior methods, it seems very difficult to easily obtain a catalyst that has at the same time bimodal porosity with a high volume of mesoporous volume, together with enough macroporous volume, a very high mesopore median diameter and a hydro-dehydrogenative active phase. Furthermore, the increase in porosity is often at the expense of the specific surface and mechanical resistance.

Surprisingly, the applicant discovered that a catalyst prepared from an alumina resulting from the calcination of a specific alumina gel with a targeted alumina content achieved by commixing a hydro-dehydrogenative active phase with calcined alumina, has a particularly interesting pore structure for hydroprocessing heavy feeds, while having a suitable active phase content.

### OBJECT OF THE INVENTION

The invention relates to a hydroconversion/hydroprocessing residue catalyst having an optimised pore distribution and an active phase commixed in a calcined aluminium matrix.

The invention also relates to a method for preparing a residue catalyst for hydroconversion/hydroprocessing by commixing the active phase with a particular alumina.

The invention also relates to the use of the catalyst in hydroprocessing, including hydroprocessing heavy feeds.

### SUMMARY OF THE INVENTION

The invention involves a process for preparing an active phase commixing catalyst, comprising at least one metal from the periodic table group VI B, possibly at least one metal from group VIII of the periodic table, possibly phosphorus and a predominantly aluminium calcined matrix oxide, comprising the following steps:
a) a step of dissolving in water an acid aluminium precursor chosen from among aluminium sulphate, aluminium chloride and aluminium nitrate at a temperature between 20 and 90° C., a pH between 0.5 and 5, for a period of between 2 and 60 minutes;
b) a step for adjusting the pH by adding into the suspension obtained in step a) at least one base precursor chosen from among sodium aluminate, potassium aluminate, ammonia, sodium hydroxide, or potassium hydroxide, at a temperature of between 20 and 90° C., with a pH between 7 and 10, for between 5 and 30 minutes.
(c) a step for co-precipitation of the suspension obtained after step b) by adding into the suspension at least one base precursor chosen from sodium aluminate, potassium aluminate, ammonia, sodium hydroxide or potassium hydroxide and at least one acid precursor selected from aluminium sulphate, aluminium chloride, aluminium nitrate, sulphuric acid, hydrochloric acid or nitric acid, with at least one base or acid precursor containing aluminium; the relative flow rate of the acidic and base precursors is chosen so as to obtain a pH of the reaction medium of between 7 and 10 and the flow rate of the acidic and base precursors containing aluminium is set so as to obtain a final alumina concentration in the suspension of between 10 and 38 g/l;
d) a step for filtering the suspension obtained after the co-precipitation in step c) to obtain alumina gel;
e) a step for drying the alumina gel obtained in step d) to obtain a powder;
f) a step for heat treating the powder resulting from step e) at a temperature between 500 and 1000° C., for between 2 and 10 hrs in the presence or not of an air flow containing up to 60% water volume to obtain a porous calcined aluminium oxide;
g) a step of mixing the porous calcined aluminium oxide obtained with a solution containing at least one metal precursor of the active phase to form a paste;
h) a step for shaping the obtained paste;
i) a step for drying the shaped paste at a temperature less than or equal to 200° C. to obtain a dried catalyst;
j) a potential step for heat treating the dried catalyst at a temperature between 200 and 1,000° C., with or without water.
The alumina concentration in the alumina gel suspension obtained in step c) is preferably between 13 and 35 g/l, but ideally between 15 and 33 g/l inclusive.

The acid precursor is preferably selected from among aluminium sulphate, aluminium chloride and aluminium nitrate, but ideally aluminium sulphate.

The base precursor is preferably selected from among sodium aluminate and potassium aluminate, but ideally sodium aluminate.

In steps a), b), and c) the aqueous reaction medium is preferably water and the said steps are carried out while stirring, in the absence of any organic additives.

The invention also relates to a hydroconversion catalyst with a bimodal pore structure comprising:
an oxide matrix consisting predominantly of calcined aluminium;
a hydro-dehydrogenative active phase comprising at least one metal from group VIB in the periodic table, possibly at least one from group VIII, and possibly phosphorus; this active phase being at least partly commixed within the said oxide matrix consisting predominantly of calcined aluminium, this catalyst with a BET specific surface greater than 100 m2/g, a mesoporous median diameter by volume between 12 and 25 nm inclusive, a macroporous median diameter by volume between 250 and 1500 nm inclusive, a mesoporous volume as measured by intrusion using a mercury porosimeter of 0.55 ml/g or more and a total pore volume measured by mercury porosimetry of 0.70 ml/g or more.

Preferably, the median mesoporous diameter by volume determined by intrusion using the mercury porosimeter lies between 13 and 17 nm inclusive.

Preferably, the macroporous volume is between 10 and 40% of the total pore volume.

Preferably, the mesoporous volume is greater than 0.70 ml/g.

Preferably the hydroconversion catalyst does not have any micropores.

Preferably, the content of group VI B metals is between 2 and 10% by weight of trioxide of at least the VI B group metal compared to the total mass of the catalyst; the group VIII metal content is between 0.0 and 3.6% by weight of oxide from at least the group VIII metal compared to the total mass of the catalyst; the amount of phosphorus content is between 0 and 5% by weight of phosphorus pentoxide compared to the total mass of the catalyst.

The hydro-dehydrogenative active phase may be composed of molybdenum, or nickel and molybdenum, or cobalt and molybdenum.

The hydro-dehydrogenative active phase may also include phosphorus.

Preferably, the hydro-dehydrogenative active phase is fully commixed.

Part of the hydro-dehydrogenative active phase can be impregnated in the mostly aluminium calcined oxide matrix.

The invention also involves hydroprocessing heavy hydrocarbon feeds selected from atmospheric residue, vacuum residues from direct distillation, deasphalted oils, residues from conversion processes such as, for example, those from coking, from fixed bed, ebullated bed, or mobile bed hydroconversion, taken alone or in a mixture involving placing said feeds in contact with hydrogen and a catalyst prepared according to the invention procedure or a catalyst such as described above.

The process can be partly carried out in an ebullated bed at a temperature between 320 and 450° C., under partial hydrogen pressure between 3 MPa and 30 MPa, at a velocity ideally between 0.1 and 10 volumes of feed by catalyst volume per hour, and with a gaseous hydrogen ratio for liquid hydrocarbon feeds ideally between 100 and 3,000 normal cubic metres per cubic metre.

The process can be at least partially carried out on a fixed bed at a temperature between 320 and 450° C., under partial hydrogen pressure between 3 MPa and 30 MPa, at a velocity between 0.05 and 5 volumes of feed by catalyst volume per hour, and with a gaseous hydrogen ratio for liquid hydrocarbon feeds between 200 and 5000 normal cubic metres per cubic metre.

This process can be a hydrotreating method for heavy hydrocarbon feeds such as fixed bed residue comprising at least:
(a) an hydrodemetalation step;
(b) an hydrodesulphurisation step;
in which the catalyst described by the invention is used in at least one of steps a) and b).

### DETAILED DESCRIPTION OF THE INVENTION

The applicant discovered that the commixing of an alumina from a special gel prepared according to a process described below with a metal formulation containing at least one element from group VI B, possibly at least one element from group VIII and possibly phosphorus, allows the obtaining of a catalyst that simultaneously displays a high pore volume of 0.70 ml/g or more, a high median mesopores diameter representing a pore diameter between 2 and 50 nm, of between 12 and 25 nm and a high presence of a proportion of macropores representing pores greater than 50 nm in diameter, (best if the macroporous volume is between 10 and 40% of the total pore volume), but also active phase characteristics that are hydrotreatment-friendly.

In addition to reducing the number of steps, and therefore the cost of manufacturing, the interest of commixing over impregnation is that it avoids all risk of partial porosity blockage of the support medium during deposit of the active phase, with the concomitant risk of limitation problems.

Furthermore, such a catalyst exhibits significant hydrodemetalation gains compared to other commixing catalysts, and therefore requires lower operating temperatures than the others to achieve the same level of metal compound conversion.

### Terms and Characterisation Techniques

The catalyst used in the present invention presents a specific porous distribution where the macroporous and mesoporous volumes are measured by mercury intrusion and the microporous volume is measured by nitrogen adsorption.

“Macropore” refers to pores with an opening greater than 50 nm.

“Mesopores” refers to pores with an opening between 2 nm and 50 nm inclusive.

“Micropore” refers to pores with an opening of less than 2 nm.

In the following invention description, specific surface refers to the BET surface area determined by nitrogen adsorption in accordance with standard ASTM D 3663-78 established using the BRUNAUER-EMMETT-TELLER method described in “The Journal of American Society”, 60, 309, (1938).

In the following invention description, the total pore volume of alumina or of the predominantly aluminium matrix or of the catalyst means the volume measured by mercury porosimeter intrusion according to standard ASTM D4284-83 at a maximum pressure of 4,000 bar, using a surface tension of 484 dyne/cm and a contact angle of 140°. The wetting angle was set to be 140° following the recommendations found in “Techniques de l′ingénieur, traité analyse et caractérisation”, P 1050-5, by Jean Charpin and Bernard Rasneur.

In order to obtain improved accuracy, the value of the total pore volume in ml/g given in the following text corresponds to the total mercury volume (total porous volume measured by mercury porosimeter intrusion) in ml/g measured in the sample minus the value of the mercury volume in ml/g measured in the same sample at a pressure of 30 psi (approximately 0.2 MPa).

The macropore and mesopore volume of the catalyst is measured by mercury intrusion porosimetry according to standard ASTM D4284-83 at a maximum pressure of 4000 bar, using a surface tension of 484 dyne/cm and a contact angle of 140°.

The value from which mercury fills all intergranular voids is set at 0.2 MPa, and we consider that beyond this the mercury penetrates into the pores of the sample.

Macroporous catalyst volume is defined as the cumulative volume of mercury introduced at a pressure between 0.2 MPa and 30 MPa, corresponding to the volume contained in the apparent pore diameter over 50 nm.

Mesoporous catalyst volume is defined as the cumulative volume of mercury introduced at a pressure between 30 MPa and 400 MPa, corresponding to the volume contained in the pores with apparent diameter between 2 and 50 nm.

The volume of the micropores is measured by nitrogen porosimetry. Quantitative analysis of the microporosity uses the “t” method (Lippens—De Boer, 1965), which is a transformed isotherm adsorption as described in the book “Adsorption by powders and porous solids. Principles, methodology and applications” written by F. Rouquerol, J. Rouquerol and K. Sing, Academic Press, 1999.

One also defines the mesoporous median diameter (Dp meso in nm) as being a diameter where all pores smaller than this diameter total 50% of the total mesoporous volume determined by mercury intrusion porosimeter.

One also defines the macroporous median diameter (Dp macro in nm) as being a diameter where all pores smaller than this diameter total 50% of the total macroporous volume determined by mercury intrusion porosimeter.

In what follows, chemical element groups are shown based on the Chemical Abstracts Service (CAS) classification (CRC Handbook of Chemistry and Physics, CRC press, Editor-in-Chief D. R. Lide, 81st edition, 2000-2001). For example, group VIII, under the CAS classification, corresponds to column 8, 9 and 10 metals according to the new IUPAC classification.

### General Description of the Catalyst

The invention relates to a catalyst for the hydroprocessing/hydroconversion of commixed active phase residues, having at least one metal from group VI B of the periodic table, possibly at least one metal from group VIII of the periodic table, possibly phosphorus and an aluminium oxide support medium, together with its preparation process and its use in a hydrocarbon heavy feed hydrotreating process such as petroleum residues (atmospheric or vacuum).

According to the invention, the catalyst is in the form of a matrix mostly comprised of a calcined porous refractory oxide within which the active phase metals are distributed.

The invention also relates to the catalyst preparation process that is carried out by commixing a particular alumina with a metallic solution formulation adapted to the metal target for the final catalyst.

The characteristics of the gel that led to obtaining the alumina, as well as the textural properties and active phase characteristics obtained, give the catalyst, according to the invention, its specific properties.

The metals in Group VI B are preferably chosen from molybdenum and tungsten, and preferably the metal selected from Group VI B will be molybdenum.

Group VIII metals are chosen from iron, nickel and cobalt, however, nickel or cobalt, or a combination of both is preferable.

Preferred quantities of metals from group VI B and group VIII are such that the atomic metal ratio of group VIII to group VI B (VIII: VI B) is between 0.0:1 and 0.7:1, preferably within 0.05:1 and 0.6:1 and more preferably would be between 0.2:1 and 0.5:1. This ratio may be adjusted depending on the particular feed type and process used.

The preferred respective amounts of metal from group VIB and phosphorus are such that the atomic ratio of phosphorus to metals from group VIB (P/VI B) is between 0.2:1 and 1.0:1, preferably within 0.4:1 and 0.9:1 and even more preferably between 0.5:1.0 and 0.85:1.

Group VI B metal preferred content is between 2 and 10% of the trioxide metal weight from group VI B relative to the total catalyst mass, preferably between 3 and 8%, and even more preferably would be between 4 and 7% by weight.

Group VIII metal preferred content, if at least one group VIII metal is present, is between 0.0 and 3.6% of the oxide metal weight from group VIII relative to the total catalyst mass, preferably between 0.4 and 2.5%, and even more preferably would be between 0.7 and 1.8% by weight.

Phosphorus preferred content, if present, is between 0.0 and 5% of phosphorus pentoxide relative to the total catalyst mass, preferably between 0.6 and 3.5% by weight, and even more preferably would be between 1.0 and 3.0% by weight.

The predominantly alumina calcined matrix of the catalyst according to the invention has an alumina content greater than or equal to 90% and a silica content of 10% by weight at most, in equivalent SiO₂ relative to the final oxide, preferably a silica content of less than 5% by weight, but even more preferably would be less than 2% by weight.

The silica may be introduced by any technique known the person skilled in the art during the alumina gel synthesis or during the commixing.

Even more preferably, the alumina matrix would contain nothing but alumina.

The active phase catalyst commixed according to the invention is generally presented in all its forms well known to the person skilled in the art. Preferably, it would consist of extrudates having diameters generally between 0.5 and 10 mm, preferably between 0.8 and 3.2 mm and ideally between 1.0 and 2.5 mm. These may preferably be presented in the form of cylindrical, trilobal or tetralobal extrudates. Preferably its shape will be trilobal or tetralobal. The shape of the lobes may be adjusted by any known prior method.

The catalyst, commixed according to the invention, has specific textural properties.

The catalyst according to the invention has a total pore volume (TPV) of at least 0.70 ml/g—preferably 0.80 ml/g. Under the preferred method, the catalyst would have a total pore volume between 0.80 and 1.00 ml/g.

The catalyst according to the invention would have a preferred volume of macropores, Vmacro or V_{50 nm}, defined as the volume of pores having diameters greater than 50 nm, of between 10 and 40% of the total pore volume, and preferably between 20 and 35% of the total pore volume. Under the best method, the macropore volume would be between 25 and 35% of the total pore volume.

The mesoporous volume (Vₘₑₛₒ) of the catalyst is at least 0.55 ml/g, but preferably 0.60 ml/g. Under the best method, the mesoporous volume of the catalyst would be between 0.60 ml/g and 0.80 ml/g.

The median mesoporous diameter is between 12 nm and 25 nm inclusive, and preferably between 12 and 18 nm inclusive. The ideal would be for the average mesoporous diameter to be between 13 and 17 nm.

The catalyst has a median macroporous diameter between 250 and 1500 nm, preferably between 500 and 1000 nm, and ideally between 600 and 800 nm.

The catalyst, according to the present invention, has a specific surface BET (S_{BET}) of at least 100 m²/g, preferably at least 120 m²/g and ideally between 150 and 250 m²/g.

Preferably, the catalyst would have low microporosity; it would be highly preferable if no microporosity at all is detectable by nitrogen porosimetry.

If necessary, it is possible to increase the metal content by inserting a second portion of the impregnated active phase onto the catalyst already commixed with a first portion from the active phase.

It is important to stress that the catalyst according to the invention differs structurally from a catalyst obtained by simply impregnating a precursor into an alumina support medium in which the alumina forms the support medium and the active phase is introduced into the pores of this support medium. Without wanting to be bound by any particular theory, it seems that the catalyst prepared using the process according to the invention by commixing a particular alumina porous oxide with one or more metal precursors allows the obtaining of a composite in which the metals and the alumina are intimately mixed, thus creating a structure for the catalyst with a porosity and an active phase content well-suited to the desired reactions.

### Catalyst Preparation Process According to the Invention

### Main Steps

The catalyst according to the invention is prepared by commixing a porous aluminium oxide obtained from a specific alumina gel and one or several metal precursors.

The preparation process for the catalyst according to the invention is made up of the following steps:

steps a) to e): Synthesis of the porous oxide precursor gel.

f) thermal treatment of the powder obtained on completion of step e);
g) mixing the porous oxide obtained with at least one precursor from the active phase.
h) shaping the paste obtained by mixing, by extrusion for example.
i) drying the shaped paste obtained.
j) potentially, heat treatment preferably under dry air.

The solid obtained at the end of steps a) to f) undergoes a step g) for commixing. It is shaped in step h), and then it may simply be dried at a temperature below or equal to 200° C. (step i) or be dried and then subjected to a further calcination heat treatment in an optional step j).

Prior to using it in a hydrotreating process, the catalyst is usually subjected to a final sulphurisation step. This step involves activating the catalyst by at least partly converting the oxide phase under a sulphate reduction conditions. This sulphurisation treatment is well known to the person skilled in the art, and can be done by any known method already described in the literature. A standard sulphurisation method, well known to the person skilled in the art, involves heating the mixture of solids under a stream of a mixture of hydrogen and hydrogen sulphide or a stream of a mixture of hydrogen and hydrocarbons containing sulphur molecules at a temperature between 150 and 800° C., preferably between 250 and 600° C., generally in a reaction zone on a traversed bed.

### Detailed Description of the Preparation Process

The active phase commixing catalyst, according to the invention, is prepared from a specific alumina gel that is dried and subjected to heat treatment before commixing with the active phase, and then shaped.

The alumina gel preparation steps used during the preparation of the catalyst according to the invention are detailed below.

Preparing the said alumina gel comprises three successive steps: a) creating a solution of the aluminium acid precursor, b) adjusting the pH of the suspension using a base precursor, and c) a co-precipitation step of at least one acid precursor and at least one base precursor, where at least one of the two contains aluminium. At the end of the actual alumina gel synthesis, i.e. at the end of step c), the final alumina concentration in the alumina gel suspension should be between 10 and 38 g/l, preferably between 13 and 35 g/l and even more preferably between 15 and 33 g/l.

a) Creating a Solution

Step a) involves dissolving an aluminium acid precursor solution in water, effected at a temperature between 20 and 80° C., preferably between 20 and 75° C. and ideally between 30 and 70° C. The aluminium acid precursor is selected from among aluminium sulphate, aluminium chloride and aluminium nitrate, preferably aluminium sulphate. The pH of the suspension obtained is between 0.5 and 5, preferably between 1 and 4, and ideally between 1.5 and 3.5. This step advantageously contributes to an amount of alumina introduced relative to the final alumina of between 0.5 and 4%, preferably between 1 and 3%, and more preferably between 1.5 and 2.5%. The suspension is stirred for between 2 and 60 minutes, and preferably 5 to 30 minutes.

b) The pH Adjustment Step

The pH adjustment step b) consists of adding to the suspension obtained in step a) at least one base precursor selected from among sodium aluminate, potassium aluminate, ammonia, sodium hydroxide and potassium hydroxide.

Preferably, the base precursor is an aluminium precursor; either sodium aluminate or potassium aluminate. It would be highly preferable if the base precursor was sodium aluminate.

Preferably, the one or more base and acid precursors are added during this pH adjusting step in the form of an aqueous solution.

Step b) is effected at a temperature between 20 and 90° C., preferably between 20 and 80° C., and more preferably between 30 and 70° C. and at a pH between 7 and 10, preferably between 8 and 10, more preferably between 8.5 and 10 and highly preferably between 8.7 and 9.9. The duration of step b) to adjust the pH is between 5 and 30 minutes, preferably between 8 and 25 minutes, and highly preferably between 10 and 20 minutes.

c) Co-Precipitation Step (2^{nd} Precipitation)

Step c) is a precipitation step for the suspension obtained after step b) by adding into the suspension at least one base precursor selected from between sodium aluminate, potassium aluminate, ammonia, sodium hydroxide or potassium hydroxide and at least one acid precursor selected from among aluminium sulphate, aluminium chloride, aluminium nitrate, sulphuric acid, hydrochloric acid and nitric acid, and at least one base or acid precursor comprising aluminium; the selected precursors being identical or not to the precursors introduced in steps a) and b). The relative flow rate of the acid and base precursors is set so as to obtain a reaction medium pH between 7 and 10 and the flow rate of the acid and base precursors containing aluminium is set so as to obtain a final alumina concentration in the suspension of between 10 and 38 g/l, preferably between 13 and 35 g/l and ideally between 15 and 33 g/l.

Preferably, the one or more base and acid precursors are added in this co-precipitation step as an aqueous solution.

Preferably, the co-precipitation step is effected at a temperature between 20 and 90° C., but best between 30 and 70° C.

Step c) co-precipitation is carried out at a pH between 7 and 10, preferably between 8 and 10, more preferably between 8.5 and 10 and highly preferably between 8.7 and 9.9.

Step c) co-precipitation is carried out for a period of between 1 and 60 minutes, but preferably from 5 to 45 minutes.

Preferably, steps a), b) and c) are performed in the absence of any organic additives.

Preferably the alumina gel synthesis, in steps a), b) and c), is carried out while stirring.

d) Filtration Step

The alumina preparation procedure according to the invention also includes a filtration step of the suspension obtained at the end of step c).

This filtration step is conducted according to methods known to the person skilled in the art.

This filtration step is by preference followed by at least one, preferably one to three, washing steps using an aqueous solution, preferably water with an amount of water equal to the amount of the filtered precipitate.

e) Drying Step

According to this invention, the alumina gel obtained after precipitation step c) followed by filtration step d), is now dried in step e) to obtain a powder; this drying step is best carried out at a temperature greater than or equal to 120° C. or by atomisation or any other drying technique known to the person skilled in the art.

In the event that drying step e) is carried out at a temperature above 120° C., drying step d) can best be performed in a closed ventilated oven. Preferably this drying step will be carried out at a temperature between 120 and 300° C., it is ideally, however, at a temperature between 150 and 250° C.

If drying step e) is carried out by atomisation, the cake obtained at the end of the second precipitation stage followed by the filtration step should be re-suspended. This suspension is then sprayed as fine droplets in a vertical cylindrical chamber in contact with a stream of hot air to evaporate the water according to well-known principles. The powder obtained is pushed by the heat flow into a bag filter/cyclone that will separate the air from the powder.

Preferably, if drying step e) uses atomisation, it should be carried out according to the procedure described in the publication Asep Bayu Dani Nandiyanto, Kikuo Okuyama, Advanced Powder Technology, 22, 1-19, 2011.

Step f) Thermal Treatment

According to the invention, the raw material obtained after drying step e) then undergoes heat treatment step f) at a temperature between 500 and 1000° C., lasting between 2 and 10 hrs, in the presence or absence of an air stream containing up to 60% water by volume.

Preferably, this thermal treatment is performed in the presence of an air stream containing water.

Preferably, this heat treatment step f) occurs at temperatures between 540° C. and 850° C. Heat treatment step f) enables the transition from boehmite to the final alumina.

The heat treatment step can be preceded by drying at a temperature between 50° C. and 120° C., according to any known procedures.

According to the invention, the powder obtained at the end of drying step e), and after the heat treatment in step f), is commixed with one or more active phase metal precursors in step g) allowing contact between the solution or solutions containing the active phase and the powder, and then shaping the resulting material to obtain the catalyst in a step h).

Step g): Commixing

The active phase is added in one or more solutions containing at least one group VIB metal, possibly at least one metal from group VIII and optionally phosphorus. The solution or solutions can be aqueous, consist of an organic solvent or even a mixture of water and at least one organic solvent such as ethanol or toluene, for example. Preferably, the solution is aqueous-organic and even more preferable if aqueous-alcoholic. The pH of this solution may be modified by adding acid.

Among the compounds that can be introduced into the solution as source elements for group VIII preference is given to: citrates, oxalates, carbonates, hydroxycarbonates, hydroxides, phosphates, sulphates, aluminates, molybdates, tungstates, oxides, nitrates, and halides, for example, chlorides, fluorides, bromides, and acetates, or any mixture of the compounds listed here.

In relation to group VIB element sources, which are well known to the person skilled in the art, preference is given, for example, to molybdenum and tungsten: oxides, hydroxides, molybdic and tungsten acids and their salts, especially ammonium salts, ammonium heptamolybdate, ammonium tungstate, phosphomolybdic acid, phosphotungstic acid and their salts. Oxides or ammonium salts such as ammonium molybdate, ammonium heptamolybdate or ammonium tungstate should preferably be used.

The preferred source of phosphorus is orthophosphoric acid, but its salts and esters are also suitable such as alkali phosphates, ammonium phosphate, gallium phosphate or alkyl phosphates. By preference, phosphorous acids, e.g. hypophosphorous acid, phosphomolybdic acid and its salts, phosphotungstic acid and its salts are used.

An additive, for example an organic chelating agent, can beneficially be introduced in the solution if deemed necessary by the person skilled in the art.

Any other element, for example silica solution or an emulsion of a silicic precursor, can be introduced into the mixing tank at the time of this step.

Commixing is best done in a mixer, for example a “Brabender” type mixer well known to the person skilled in the art. The calcined alumina powder obtained in step f) and one or more additives or other possible elements are placed in the mixing tank. Next, the metals' precursor solution, for example nickel and molybdenum, and possibly permuted water, are added using a syringe for a period of a few minutes, typically around 2 minutes at a given mixing speed. After a paste is obtained, mixing can be continued for several minutes, for example approximately 15 minutes at 50 rpm.

Step h): Shaping

The paste obtained after the commixing step g) is then shaped following any technique known to the person skilled in the art, for example shaping by extrusion, pelletizing, by the oil droplet method, or rotary plate granulation.

Preferably, the support medium according to the invention is shaped by extrusion in the form of extrudates with diameters generally between 0.5 and 10 mm and preferably between 0.8 and 3.2 mm. Under the preferred method, it will be composed of trilobal or tetralobal extrudates sized between 1.0 and 2.5 mm in diameter.

The ideal method would be to combine the commixing step g) and the shaping step h) into a single mixing-shaping step. In this case, the paste obtained at the end of the mixing can be inserted into a capillary rheometer MTS through a die with the correct diameter, typically between 0.5 and 10 mm.

Step i): Drying

According to the invention, the catalyst obtained in commixing step g) and shaping step h) undergoes a drying step i) at temperatures of 200° C. or below, preferably less than 150° C., according to any technique known to the person skilled in the art, lasting ideally between 2 and 12 hrs

Step j): Thermal or Hydrothermal Treatment

According to the invention, the dried catalyst can then undergo an additional thermal or hydrothermal treatment in step j) at a temperature between 200 and 1,000° C., preferably between 300 and 800° C. and even more preferably between 350 and 550° C., for 2 to 10 hrs, in the presence or absence of a flow of air containing up to 60% water by volume. Several combined thermal and hydrothermal treatment cycles can be performed.

If the catalyst does not undergo further thermal or hydrothermal treatments, the catalyst is iadvantageously only dried in phase i).

If water were to be added, contact with the water vapour may occur at atmospheric pressure (steaming) or autogenous pressure (autoclave). In the case of steaming, the moisture content is preferably between 150 and 900 grams per kilogram of dry air, and even more preferably, between 250 and 650 grams per kilogram of dry air.

According to the invention, one may consider adding all or part of the metals listed for the commixing of the metal solution with porous oxide aluminium.

In one method, in order to increase the overall content of the commixed catalyst in the active phase, a part of the metals are inserted by impregnation in the catalyst created by step g) or h), using any methods known to the person skilled in the art, the most common being dry impregnation.

In another method, the entire metallic phase is introduced during the preparation by commixing the porous aluminium oxide and no additional impregnation step is therefore necessary. Preferably, the active phase of the catalyst is completely commixed in the calcined porous aluminium oxide.

### Description of the Method of Use for the Catalyst According to the Invention

The catalyst according to the invention may be applied in hydrotreating procedures to convert heavy hydrocarbon feeds containing sulphur and metallic impurities. One objective of using the catalysts according to the present invention relates to performance improvement, in particular in hydrodemetalation and hydrodesulphurisation, while improving the ease of preparation compared to prior known catalysts. The catalyst according to the invention enables hydrodemetalation and hydrodeasphalting performance improvement compared with conventional catalysts, while showing high stability over time.

Generally, the hydrotreating processes for converting heavy hydrocarbon feeds containing sulphur and metal impurities operate at a temperature between 320 and 450° C., under a partial hydrogen pressure between 3 MPa and 30 MPa, at a preferable velocity of between 0.05 and 10 volumes of feed per catalyst volume per hour, and with a gaseous hydrogen ratio for liquid hydrocarbon feeds ideally between 100 and 5,000 normal cubic metres per cubic metre.

### Feeds

Feeds treated using the process according to the invention are preferably selected from among atmospheric residues, vacuum residues from direct distillation, deasphalted oils, residues from conversion processes such as, for example, those from coking, hydroconversion on a fixed, ebullated, or mobile bed, processed alone or in a mixture. These feeds can be preferably used as such or diluted by a hydrocarbon fraction or a mixture of hydrocarbon fractions chosen from among the products of the Fluid Catalytic Cracking (FCC) process, a Light Cycle Oil (LCO), a Heavy Cycle Oil (HCO), Decanted Oil (DO), a slurry, or coming from distillation or fractional diesel fuel including those obtained by vacuum distillation referred to as Vacuum Gas Oil (VGO). Heavy feeds can preferably include fraction ends from a coal liquefaction process, aromatic extracts, or any other carbohydrate fractions.

Such heavy feeds are usually more than 1% by molecule weight with a boiling point greater than 500° C., a metal content (Ni+V) greater than 1 ppm by weight, preferably greater than 20 ppm, and even more preferably having over 50 ppm in weight, asphaltene content, precipitated in heptane, over 0.05% by weight, preferably greater than 1% by weight, and highly preferable over 2%.

Heavy feeds can also be advantageously mixed with coal in powder form; this mixture is commonly called slurry. These feeds may advantageously be by-products from coal conversion then mixed again with fresh coal. The coal content in the heavy feed is usually and preferably a ¼ Oil/Coal ratio and can advantageously vary widely between 0.1 and 1. Coal may contain lignite, be a sub-bituminous coal, or even oil. Any other type of coal is suitable for the use of the invention, in either fixed bed or ebullated bed reactors.

### Implementation of the Catalyst According to the Invention

In accordance with the invention, the active phase commixed catalyst is preferentially used in the first catalytic beds of a process that successively uses at least one hydrodemetalation step and at least one hydrodesulphurisation step. The process according to the invention can be advantageously implemented in one to ten successive reactors; the catalyst, or catalysts according to the invention, may preferably be fed into one or more reactors and/or in all or some of the reactors.

Under a preferred method, switchable reactors, that is to say reactors operating alternately, in which hydrodemetalation catalysts according to the invention are preferably implemented, may be used upstream of the unit. In this preferred method, the switchable reactors are then followed by reactors in series, in which hydrodesulphurisation catalysts are implemented that can be prepared using any method well known to the person skilled in the art.

Using a highly preferable method, two switchable reactors are used ahead of the unit, preferably for hydrodemetalation and containing one or more catalysts according to the invention. They are advantageously followed by one to four reactors in series, preferably used for hydrodesulphurisation.

The invention process can preferably be implemented in a fixed bed with the objective of eliminating metals and sulphur and lowering the average hydrocarbon boiling point. Where the invention process is implemented in a fixed bed, the preferred temperature is between 320° C. and 450° C., preferably 350° C. to 410° C., under a preferred partial hydrogen pressure between 3 MPa and 30 MPa, preferably between 10 and 20 MPa, at a space velocity best between 0.05 and 5 feed volume by catalyst volume per hour, and with a gaseous hydrogen ratio over liquid hydrocarbon feeds best between 200 and 5000 normal cubic metres by cubic metres, preferably 500 to 1500 normal cubic metres by cubic metres.

The process according to the invention may also be favourably implemented partly in an ebullated bed for the same feeds. Where the invention process is implemented in an ebullated bed, the catalyst is preferably implemented at temperatures between 320° C. and 450° C., under a preferred partial hydrogen pressure between 3 MPa and 30 MPa, preferably between 10 and 20 MPa, at a space velocity best between 0.1 and 10 feed volume per catalyst volume per hour, and with a gaseous hydrogen ratio over liquid hydrocarbon feeds best between 100 and 3000 normal cubic metres per cubic metre, preferably 200 to 1200 normal cubic metres per cubic metre.

In a preferred method, the method according to the invention is implemented in a fixed bed.

Prior to their implementation in the process according to the invention, the catalysts under the present invention are preferably subjected to a sulphurisation treatment to transform, at least in part, the metallic species into sulphides before placing them in contact with the feed to be treated. This sulphurisation treatment is well known to the person skilled in the art and can be done using any known method already described in literature. A standard sulphurisation method, well known to the person skilled in the art, involves heating the mixture of solids under a stream of a mixture of hydrogen and hydrogen sulphide or a stream of a mixture of hydrogen and hydrocarbons containing sulphur molecules, at a temperature between 150 and 800° C., preferably between 250 and 600° C., generally in a reaction zone on a traversed bed.

The sulphurisation treatment can be carried out ex situ (before introducing the catalyst into the hydrotreating/hydroconversion reactor) or in situ using an organosulphur H₂S precursor agent, for example dimethyl disulphide (DMDS).

The following examples illustrate the invention without, however, limiting the scope.

### EXAMPLES

### Example 1: Preparation of Metallic Solutions A, B, C and D

Solutions A, B, C and D, used for the preparation of catalysts A1, A2, A3, B1, C1, D1, D3, were prepared by dissolving the precursors of the following phases MoO₃, Ni (OH)₂, and possibly H₃PO₄ in water. All of these precursors are from Sigma-Aldrich. The concentration of elements of the various solutions is shown in the following table.

TABLE 1
Molar concentration of the prepared
aqueous solution, expressed in mol/l

| | | | | Ni/Mo | P/Mo |
|---|---|---|---|---|---|
| Catalyst | Mo | Ni | P | mol/mol | mol/mol |
| A | 0.49 | 0.23 | 0.27 | 0.47 | 0.55 |
| B | 0.68 | 0.31 | 0.36 | 0.45 | 0.53 |
| C | 0.85 | 0.39 | 0.45 | 0.46 | 0.53 |
| D | 0.84 | 0.38 | No | 0.45 | ** |

### Example 2: Preparation of Commixed Catalysts A1, B1, According to the Invention

Two catalysts, A1 and B1 following the invention, are prepared as follows:

### Preparation of Alumina: Batch A1 (A1)

A laboratory reactor with a capacity of approximately 7,000 ml is used.

Synthesis occurs at 70° C. while being stirred. There is a water column of 1679 ml.

We prepare 5 l of solution with an alumina concentration set at 27 g/l in the final suspension and with a first step total alumina contribution rate of 2.1%.

### Step a) Preparing a Solution:

70 ml of aluminium sulphate is put at one time into the reactor containing the water column. The pH should remain between 2.5 and 3 and be monitored for 10 min. This step contributes a level of 2.1% alumina to the total alumina mass resulting from the gel synthesis.

### Step b) pH Adjustment

After the aluminium sulphate solution step, we gradually add about 70 ml of sodium aluminate solution. The objective is to arrive at a pH between 7 and 10 within 5 to 15 min.

### Step c) Co-Precipitation:

Into the suspension obtained in step b) are added over 30 min.:

1020 ml of aluminium sulphate at a flow rate of 34 ml/min,
1020 ml of sodium aluminate at a flow rate of 34 ml/min,
1150 ml of distilled water at a flow rate of 38.3 ml/min.

### Step d): At the End of the Preparation, the Suspension is Filtered and Washed Several Times to Obtain an Alumina Gel.

Step e): The Cake is Overdried in an Oven for at Least One Night at 200° C. Powder is Obtained that Needs to be Shaped.

The main characteristics of the alumina gel obtained in step e) are listed in Table 2.

TABLE 2
Characteristics of the gel used for preparing the alumina.

| Phase detected | Loss on | S | Na |
|---|---|---|---|
| by X-ray | ignition | content | content |
| diffraction (XRD) | (% m/m) | (ppm) | (ppm) |
| Boehmite | 20.7 | 350 | 60 |

Step f): The Resulting Powder is then Calcined at 800° C. for 2 Hrs to Obtain the Boehmite to Alumina Transition.

Alumina Al (A1) is obtained that serves as an A1 catalyst matrix.

### Alumina: Al Batch (B1)

Al (B1) alumina, serving as a B1 catalyst matrix, is prepared in exactly the same way as the alumina described above.

### Obtaining A1 and B1 Catalysts

The A and B impregnation solutions were respectively mixed in the presence of alumina Al (A1) and Al (B1) as described below to obtain the A1 and B1 catalysts.

### Step g):

Commixing takes place in a “Brabender” type mixer having an 80 cm³ tank and a mixing speed of 30 rpm. The calcined powder is placed in a mixing tank. Then the A or B solution (MoNi (P)) is added at a speed of 15 rpm. Mixing is maintained for 15 minutes after obtaining a paste.

### Step h): Shaping

The obtained paste is placed into a piston extruder through a 2.1 mm diameter trilobal die, at an extrusion rate of 50 cm/min.

### Step i): Drying

The catalyst extrudates thus obtained are then dried overnight in an oven at 80° C.

### Step j): Heat Treatment

The dried extrudates are then calcined at 400° C. for 2 hrs under an air flow (LHSV=1 L/hr/g).

The A1 and B1 thus calcined catalysts have the characteristics listed in Table 4 below.

### Example 3 (Comparative): Preparation of an E Catalyst by Dry Impregnation of a Shaped Alumina Support Medium

The E catalyst is prepared by mixing-shaping the boehmite, followed in sequence by calcination and hydrothermal treatment to shape an S(E) support medium before dry impregnation of an aqueous solution in such a way that the metal content is the same as that introduced by commixing the A1 catalyst.

### Preparing the S(E) Support Medium

The aqueous sodium aluminate precursors and the aluminium sulphate are prepared from a stock solution.

A laboratory reactor with a capacity of approximately 7000 ml is used.

Synthesis occurs at 70° C. while being stirred. There is one column of 1679 ml of water.

5 l of solution is prepared at 60 g/l of final alumina and with a first step total alumina contribution rate of 2.1%.

### Step a) Preparing a Solution:

156 ml of aluminium sulphate is put at one time into the reactor containing the column of water. The pH should remain between 2.5 and 3 and be monitored for 10 min. This step contributes a level of 2.1% alumina by weight to the total alumina mass resulting from the gel synthesis.

### Step b) pH Adjustment

After the aluminium sulphate annealing step, we gradually add about 156 ml of sodium aluminate. The objective is to arrive at a pH between 7 and 10 within 5 to 15 min.

### Step c) Co-Precipitation:

Into the suspension obtained in step b) are added over 30 min.:

2270 ml of aluminium sulphate at a flow rate of 76 ml/min,
2270 ml of sodium aluminate at a flow rate of 76 ml/min,
2600 ml of distilled water at a flow rate of 85.5 ml/min.

The co-precipitation pH is maintained at between 7 and 10.

At the end of the synthesis, the suspension is filtered and washed several times.

The cake is over-dried in an oven for at least one night at 200° C. Powder is obtained needs to be shaped.

Shaping is carried out in a Brabender type mixer with an acid content of 1% (total, relative to the dry alumina), a neutralisation rate of 20% and acid and base loss on ignition of respectively 62 and 64%.

Extrusion is carried out on a piston extruder through a 2.1 mm diameter trilobal die.

After extrusion, the rods are dried overnight at 80° C. and calcined 2 hrs at 800° C. under a humid airflow in a tubular kiln (LHSV=1 l/hr/g with 30% water). S(E) support medium extrudates are obtained with the characteristics listed in Table 3.

TABLE 3
example of characteristics obtained for S(E) support mediums

| Vₘₑₛₒ | V_{macro} | Dpₘₑₛₒ | Dp_{macro} | Vₚₜ | S_{BET} |
|---|---|---|---|---|---|
| (ml/g) | (ml/g) | (nm) | (nm) | (ml/g) | (m²/g) |
| 0.70 | 0.11 | 16.5 | 240 | 0.91 | 130 |

### Preparing the E Catalyst

The S(E) support medium is then impregnated with an NiMoP metallic phase by the so-called dry method using the same precursors as in Example 1, which are MoO₃, Ni(OH)₂, and H₃PO₄. The metal concentration in the solution defines the content, which was chosen so as to be comparable to that of the A1 catalyst. After impregnation, the impregnated support medium undergoes a 24 hour curing step in a water saturated atmosphere before being dried under air for 12 hours at 80° C. and then calcined in air at 400° C. for 2 hours. Catalyst E is obtained. The metal content was verified and listed in Table 4.

### Example 4 (Comparative): Preparation of a Nonconforming A2 Commixed Catalyst

To obtain the A2 catalyst, solution A is mixed in the presence of an Al (A2) alumina prepared in a non-compliant way, in that the final alumina concentration in the suspension of step c) is not in accordance with the invention (60 g/l).

### Preparation of Al (A1) Alumina:

The aqueous sodium aluminate precursors and the aluminium sulphate are prepared from a stock solution.

A laboratory reactor with a capacity of approximately 7000 ml is used.

Synthesis occurs at 70° C. while being stirred. There is a column of 1679 ml of water.

5 l of solution are prepared at 60 g/l of the final alumina and with a first step contribution rate of 2.1%.

### Step a) Preparing a Solution:

156 ml of aluminium sulphate is put at one time into the reactor containing the column of water. The pH should remain between 2.5 and 3 and be monitored for 10 min. This step contributes a level of 2.1% alumina by weight to the total alumina mass resulting from the gel synthesis.

### Step b) pH Adjustment

After preparing the aluminium sulphate solution, we gradually add about 156 ml of sodium aluminate. The objective is to arrive at a pH between 7 and 10 within 5 to 15 min.

### Step c) Co-Precipitation:

Into the suspension obtained in step b) are added over 30 min.:

2270 ml of aluminium sulphate at a flow rate of 76 ml/min,
2270 ml of sodium aluminate at a flow rate of 76 ml/min,
2600 ml of distilled water at a flow rate of 85.5 ml/min.

The co-precipitation pH is kept between 7 and 10.

At the end of the preparation, the suspension is filtered and washed several times.

The cake is over-dried in an oven for at least one night at 200° C. The resulting powder is then calcined at 800° C. for 2 hrs

### Preparing the A2 Catalyst

Commixing takes place in a “Brabender” type mixer having an 80 cm³ tank and a mixing speed of 50 rpm. The calcined powder is placed in a mixing tank. Then the A solution MoNi(P) is added at a speed of 15 rpm. Mixing is maintained for 15 minutes after obtaining a paste. The paste thus obtained is extruded using a piston extruder through a 2.1 mm die. The extrudates thus obtained are then dried overnight in an oven at 80° C. and then calcined at 400° C., 2 hrs under airflow (1 l/hr/g).

The resulting A2 catalyst has the characteristics listed in Table 4. It has a disproportionately high macroporous volume, at the expense of the mesoporous volume that remains low and the median mesoporous (Dₚₘₑₛₒ) 1 diameter that remains low (less than 8 nm).

### Example 5 (Comparative): Preparation of a Non-Conformant A3 Commixed Catalyst

### Preparation of Boehmite B(A3)

Preparing the boehmite is identical to steps a) to e) of the alumina Al (A1) preparation process, but no step f) heat treatment is involved.

A laboratory reactor with a capacity of approximately 7000 ml is used.

Synthesis occurs at 70° C. while being stirred. There is a column of 1679 ml of water.

We prepare 5 l of solution at an alumina concentration set at 27 g/l in the final suspension and with a first step total alumina contribution rate of 2.1%.

### Step a) Preparing a Solution:

70 ml of aluminium sulphate is put at one time into the reactor containing the column of water. The pH should remain between 2.5 and 3 and is monitored for 10 min. This step contributes introduction of 2.1% alumina of the total alumina mass resulting from the gel synthesis.

### Step b) pH Adjustment

After preparing the aluminium sulphate solution, we gradually add about 70 ml of sodium aluminate. The objective is to arrive at a pH between 7 and 10 within 5 to 15 min.

### Step c) Co-Precipitation:

Into the suspension obtained in step b) are added over 30 min.:

1020 ml of aluminium sulphate at a flow rate of 34 ml/min,
1020 ml of sodium aluminate at a flow rate of 34 ml/min,
1150 ml of distilled water at a flow rate of 38.3 ml/min.

The co-precipitation pH is maintained between 7 and 10.

At the end of the synthesis, the suspension is filtered and washed several times (step d).

The cake is over-dried (step e) in an oven for at least one night at 200° C. B(A3) powder is obtained that needs to be shaped. No calcination of the powder is involved at this stage.

### Preparing the A3 Catalyst

The A solution is then mixed in the presence of the B(A3) alumina precursor powder (in the form AlOOH) prepared above, up to drying step e). The powder, not having been calcined, is therefore a boehmite powder. The mixing-extrusion conditions applied are exactly the same as those described above in example 4. The extrudates thus obtained are then dried overnight in an oven at 80° C., then calcined at 400° C., 2 hrs under air (1 l/hr/g).

The resulting A3 catalyst has the characteristics listed in Table 4. Compared to catalyst A2, the macroporous volume is lower, but still high, to the detriment of a very low mesoporous volume. The median mesoporous diameter (Dpmeso) is unchanged compared to the A2 catalyst, therefore low (less than 8 nm).

TABLE 4
Properties of the prepared catalysts

| Catalyst | E | A1 | B1 | A2 | A3 |
|---|---|---|---|---|---|
| Method of | Compar- | According to | | Compar- | Compar- |
| preparation | ative | the invention | | ative | ative |
| Aluminium | Cal- | Cal- | Cal- | Cal- | Dried |
| precursor | cined | cined | cined | cined | |
| status | | | | | |

| | | |
|---|---|---|
| Metal | Dry | [symbol] Commixing [symbol] |
| introduction | impreg- | |
| method | nation | |

Textural properties by mercury pycnometry (except BET)

| | | | | | |
|---|---|---|---|---|---|
| Vₜₒₜₐₗ (ml/g) | 0.77 | 0.94 | 0.92 | 1.08 | 0.71 |
| Vₘₑₛₒ (mL/g) | 0.54 | 0.60 | 0.65 | 0.51 | 0.36 |
| D_{p meso}(nm) | 14.7 | 13.1 | 13.4 | 7.7 | 7.4 |
| Vmacro (ml/g) | 0.23 | 0.33 | 0.27 | 0.58 | 0.35 |
| (% of total | (30%) | (35%) | (29%) | (54%) | (49%) |
| volume) | | | | | |
| D_{p macro} (nm) | 574 | 627 | 743 | 1672 | 1053 |
| S_{BET} (m²/g) | 157 | 201 | 194 | 227 | 311 |
| Microporosity | 0 | 0 | 0 | 0 | 250 |
| S_{micro} (m²/g) | | | | | |

Metal content analysis (by X-ray fluorescence)

| | | | | | |
|---|---|---|---|---|---|
| % wt MoO₃ | 6.05 | 6.12 | 8.17 | 5.94 | 5.89 |
| impregnated | | | | | |
| % wt NiO | 1.44 | 1.48 | 1.94 | 1.45 | 1.47 |
| impregnated | | | | | |
| % wt P₂O₅ | 1.68 | 1.63 | 2.25 | 1.58 | 1.59 |
| impregnated | | | | | |

### Example 6: Molecular Evaluation Test of Catalyst Models A1, B1, A2, A3 and E

In applications such as hydrotreating, in particular, vacuum distillates and residues, the hydro-dehydrogenative function plays a critical role given the high aromatic compounds content of these feeds. The toluene hydrogenation test was thus used to determine the interest of catalysts in applications such as those targeted here, particularly hydrotreating residues.

The catalysts, previously described in examples 2 to 5, are dynamically sulphurised in situ in the tubular fixed bed reactor traversed by a Microcat type pilot unit (manufacturer: Vinci); fluids circulate from top to bottom. The hydrogenating activity measurements were carried out immediately after pressurised sulphurisation, without admitting air, with the hydrocarbon feed that was used to sulphurise the catalysts.

The sulphurisation and test feed is composed of 5.8% dimethyl disulphide (DMDS), 20% toluene and 74.2% cyclohexane (by weight).

The sulphurisation is carried out between room temperature and 350° C., with a temperature gradient of 2° C./min, an LHSV=4 hrs⁻¹ and H₂/HC=450 NI/I. The catalytic test is carried out at 350° C. at LHSV=2 hrs⁻¹ and H₂/HC equal to that of the sulphurisation, with a minimum sampling of 4, analysed by gas chromatography (GC).

We thus measure the stabilised catalytic activities of equal volumes of the catalysts in the hydrogenation reaction of toluene.

Detailed conditions for measurement activity are as follows:
Total pressure: 6.0 MPa
Toluene pressure: 0.37 MPa
Cyclohexane pressure: 1.42 MPa
Methane pressure 0.22 MPa
Hydrogen pressure: 3.68 MPa
H2S pressure: 0.22 MPa
Catalyst volume: 4 cm³ (Extrudate length between 2 to 4 mm)
Hourly space velocity: 2 hrs-1
Sulphurisation and test temperature: 350° C.

The liquid effluent samples are analysed by gas chromatography. Determining the unconverted toluene molar concentrations (T) and concentrations of hydrogenation products—methylcyclohexane (MCC6) ethylcyclopentane (EtCC5) and dimethylcyclopentanes (DMCC5), allow calculation of a toluene hydrogenation XHYD rate defined by:

$${X}_{HYD} ( \% ) = 100 \frac{MCC 6 + EtCC 5 + DMCC 5}{T + MCC 6 + EtCC 5 + DMCC 5}$$

The hydrogenation reaction of toluene is of an order of 1 under the test conditions employed and the reactor behaves like an ideal piston reactor; we calculate the hydrogenating activity AHYD of the catalysts by applying the formula:

$${A}_{HYD} = ln ( \frac{100}{100 - {X}_{HYD}} )$$

Table 5 below allows comparison of the hydrogenating activity of the catalysts.

TABLE 5
Performance comparison of the hydrogenation of toluene
by catalysts according to the invention (A1, B1) and comparison
with the A2, A3 and E non-compliant catalysts.

| | | | | | A_{HYD} |
|---|---|---|---|---|---|
| | Alumina | | | | relative |
| | precursor | | | | Compared |
| Catalyst | status | Compliant? | % MoO₃ | Commixed? | to E (%) |
| A1 | Calcined | Yes | 6% | Yes | 90 |
| B1 | Calcined | Yes | 8% | Yes | 120 |
| A2 | Calcined | No | 6% | Yes | 45 |
| A3 | Dried | No | 6% | Yes | 18 |
| E | Calcined | No | 6% | No | 100 |

These catalytic results show the specific effect of commixing a metal solution with an alumina using the method of preparation according to the invention, i.e. continuous hydrogenating activity, as compared to a standard catalyst impregnated by an active phase equivalent (catalyst E), and clearly better than catalysts commixed with calcined alumina from alumina gel prepared non-compliantly (catalyst A2) or from boehmite (catalyst A3), together with a lower manufacturing cost and greater ease of preparation.

### Example 7: Evaluation of A1, B1, A2, A3, and E Catalysts on a Test Batch

The A1 and B1 catalysts prepared according to the invention, but also the solid comparisons A2, A3 and E were submitted to a catalytic reactor batch-processed test, perfectly stirred, on a vacuum residue (VR) Arabian Light feed—the characteristics of which are described in Table 6.

TABLE 6
Characteristics of the VR Arabian Light feed used

| | | VR Light Arabian |
|---|---|---|
| 15/4 density | | 0.9712 |
| Viscosity at 100° C. | mm²/s | 45 |
| Sulphur | % wt | 3.38 |
| Nitrogen | ppm | 2257 |
| Nickel | ppm | 10.6 |
| Vanadium | ppm | 41.0 |
| Aromatic carbon | % | 24.8 |
| Conradson carbon | % wt | 10.2 |
| Asphaltene C7 | % wt | 3.2 |
| SARA | | |
| Saturated | % wt | 28.1 |
| Aromatics | % wt | 46.9 |
| Resins | % wt | 20.1 |
| Asphaltenes | % wt | 3.5 |
| Simulated distillation | | |
| PI | ° C. | 219 |
| 5% | ° C. | 299 |
| 10% | ° C. | 342 |
| 20% | ° C. | 409 |
| 30% | ° C. | 463 |
| 40% | ° C. | 520 |
| 50% | | 576 |
| DS: PF ° C. | ° C. | 614 |
| DS: res disti | % wt | 57 |

To do this, after an ex-situ sulphurisation step consisting of circulating an H₂S/H₂ gas mixture for 2 hours at 350° C., 15 ml of catalyst was introduced airtight into the batch reactor then covered with 90 ml of feed. The guideline operating conditions are as follows:

TABLE 7
Operating conditions implemented in the batch reactor

| | | |
|---|---|---|
| Total pressure | 9.5 | MPa |
| Test temperature | 370° | C. |
| Test duration | 3 | hours |

At the end of the test, the reactor was cooled and after triple stripping the atmosphere under nitrogen (10 minutes at 1 MPa), the effluent was collected and analysed by x-ray fluorescence (sulphur and metals).

The HDS rate is defined as follows:

HDS (%)=((% wgt S)_{feed}−(% wgt S)ᵣₑₜᵤᵣₙ)/(% wgt S)_{feed}×100

Similarly, the HDM rate is defined as follows:

HDM (%)=((ppm wgt Ni+V)_{feed}−(ppm wgt Ni+V)ᵣₑₜᵤᵣₙ)/(ppm wgt Ni+V)_{feed}×100

The catalyst performance is summarised in Table 8. It clearly shows that commixing according to the invention, in addition to reducing catalyst manufacturing costs provides results at least as good as catalysts prepared by dry impregnation, and much better than catalysts commixed from non-compliant support mediums (concentration in non-compliant gel alumina or commixing from uncalcined boehmite powder);

TABLE 8
HDS and HDM catalyst performance according to the invention (A1,
B1) and comparison with non-compliant A2, A3 and E catalysts.

| Catalysts | HDS (%) | HDM (%) |
|---|---|---|
| A1 (according to the | 51.8 | 77.4 |
| invention) | | |
| B1 (according to the | 52.1 | 76.3 |
| invention) | | |
| A2 (comparative) | 35.6 | 68.3 |
| A3 (comparative) | 28.4 | 63.2 |
| E (comparative) | 50.3 | 76.1 |

The use of a specific alumina gel, according to the protocol described, allows the obtaining of active phase commixed catalysts at low cost while maintaining hydrodesulphurisation and hydrodemetalation performance.

### Example 8: A1 and B1 Catalyst Evaluation Under Fixed Bed Hydrotreating According to the Invention and Comparison with the Catalytic Performance of Catalyst E

A1 and B1 catalysts prepared according to the invention were compared in oil residue hydrotreating tests against the performance of catalyst E. The feed consisted of a mixture of atmospheric residue (AR) of Middle East origin (Arabian medium) and a vacuum residue (Arabian Light). The corresponding feed is characterised by high levels of Conradson carbon (14.4% in weight) and asphaltenes (6.1% by weight) and a high amount of nickel (25 ppm by weight), vanadium (79 ppm by weight) and sulphur (3.90% in weight). Full features of these feeds are listed in Table 9.

TABLE 9
Feed characteristics AR AM/VR AL used for testing

| | | Mix AR AM/VR AL |
|---|---|---|
| 15/4 density | | 0.9920 |
| Sulphur | % wt | 3.90 |
| Nitrogen | ppm | 2995 |
| Nickel | ppm | 25 |
| Vanadium | ppm | 79 |
| Conradson carbon | % wt | 14.4 |
| Asphaltene C7 | % wt | 6.1 |
| Simulated distillation | | |
| PI | ° C. | 265 |
| 5% | ° C. | 366 |
| 10% | ° C. | 408 |
| 20% | ° C. | 458 |
| 30% | ° C. | 502 |
| 40% | ° C. | 542 |
| 50% | ° C. | 576 |
| 60% | ° C. | 609 |
| 70% | ° C. | — |
| 80% | ° C. | — |
| 90% | ° C. | — |
| DS: PF ° C. | ° C. | 616 |
| DS: res disti | % wt | 61 |

After a sulphurisation step by circulation in the reactor of a diesel fuel cut supplemented with DMDS brought to a final temperature of 350° C., we operate the unit with the oil residue described below in the Table 10 operating conditions.

TABLE 10
Operating conditions implemented in the fixed bed reactor.

| | | |
|---|---|---|
| Total pressure | 15 | MPa |
| Test temperature | 370° | C. |
| Hourly space velocity of the | 0.8 | hrs⁻¹ |
| residue. | | |
| Hydrogen flow | 1200 | std l._{H2}/l._{feed} |

We inject the feed mixture of AR AM/VR AL, then we rise to the test temperature. After a stabilisation period of 300 hours, the hydrodesulphurisation (HDS) and hydrodemetalation (HDM) performances are identified.

The performances obtained (Table 11) confirm the results of example 7, i.e. the good performance of commixing catalysts according to the invention compared to the reference catalyst prepared according to the dry impregnation method. However, preparation cost gains and greater ease of the latter were found by preparing according to the invention.

TABLE 11
HDS and HDM performances for A1 and
B1 catalysts compared to catalyst E

| Catalysts | HDS (%) | HDM (%) |
|---|---|---|
| A1 (according to the | −2.5% | +0.3% |
| invention) | | |
| B1 (according to the | −0.4% | −0.5% |
| invention) | | |
| E (comparative) | Base | Base |

### Example 9: Preparation of Commixed C1 and D1 Catalysts (According to the Invention) for Hydroconversion and D3 Catalyst Prepared by Commixing with Boehmite Powder (Comparative)

The C and D impregnation solutions, as prepared in example 1, are mixed in the presence of the initial alumina Al(A1) used for the A1 catalytic converter synthesis according to the protocol of example 2, to respectively obtain catalysts C1 and D1.

C1 and D1 catalysts exhibit the characteristics indicated in Table 12 below.

Boehmite B(A3) powder prepared in example 5 is commixed with solution D according to the protocol described in example 5 to obtain the D3 catalyst.

TABLE 12
Hydroconversion catalysts prepared

| Catalyst | D3 | C1 | D1 |
|---|---|---|---|
| Objective of the | Comparative | According to | According to |
| preparation | | the invention | the invention |
| Aluminium precursor | Dried | Calcined | Calcined |
| status | | | |

| | |
|---|---|
| Metal introduction | [symbol] Commixing [symbol] |
| method | |

Textural properties by mercury pycnometry (except BET)

| | | | |
|---|---|---|---|
| Vtotal (ml/g) | 0.72 | 0.91 | 0.97 |
| Vmeso (mL/g) | 0.40 | 0.61 | 0.65 |
| Dp meso (nm) | 6.7 | 13.7 | 13.4 |
| Vmacro (ml/g) | 0.32 | 0.30 | 0.32 |
| (% of total volume) | (44%) | (33%) | (33%) |
| Dp macro (nm) | 824 | 678 | 645 |
| S_{BET} (m²/g) | 287 | 187 | 194 |
| Microporosity | 250 | 0 | 0 |
| (m²/g) | | | |

Metal content analysis (by X-ray fluorescence)

| | | | |
|---|---|---|---|
| % wt MoO₃ | 10.07 | 10.23 | 9.89 |
| impregnated | | | |
| % wt NiO | 2.38 | 2.47 | 2.34 |
| impregnated | | | |
| % wt P₂O₅ | No | 2.07 | No |
| impregnated | | | |

### Example 10: Test Batch Evaluation Under the Hydroconversion Conditions of Catalysts C1, D1 and D3

Catalysts C1 and D1 prepared according to the invention as well as the comparative catalyst D3 were subjected to a catalytic reactor batch test perfectly stirred, on a VR Safanyia type feed (Arabian Heavy, see specifications in Table 13).

TABLE 13
Characteristics of the VR Safanyia feed used

| | | VR Safanyia |
|---|---|---|
| 15/4 density | | 1.0290 |
| Viscosity at 100° C. | mm²/s | 1678 |
| Sulphur | % wt | 5.05 |
| Nitrogen | ppm | 3724 |
| Nickel | ppm | 47 |
| Vanadium | ppm | 148 |
| Conradson carbon | % wt | 20 |
| Asphaltene C7 | % wt | 14 |
| SARA | | |
| Saturated | % wt | 11 |
| Aromatics | % wt | 39 |
| Resins | % wt | 34 |
| Asphaltenes | % wt | 14 |
| Simulated distillation | | |
| PI | ° C. | |
| 5% | ° C. | 459.6 |
| 10% | ° C. | 490.0 |
| 20% | ° C. | 531.2 |
| 30% | ° C. | 566.2 |
| 40% | ° C. | 597.6 |
| DS: PF ° C. | ° C. | 611.1 |
| DS: res disti | % wt | 44.0 |

To do this, after an ex-situ sulphurisation step by circulating an H₂S/H₂ gas mixture for 2 hours at 350° C., a volume of 15 ml of catalyst is loaded airtight into the batch reactor then covered with 90 ml of feed. The guideline operating conditions are as follows:

TABLE 14
Operating conditions implemented in
the batch reactor (hydroconversion).

| | | |
|---|---|---|
| Total pressure | 14.5 | MPa |
| Test temperature | 430° | C. |
| Test duration | 3 | hours |

At the end of the test, the reactor is cooled and after triple stripping the atmosphere under nitrogen (10 minutes at 1 MPa), the effluent is collected and analysed by x-ray fluorescence (sulphur and metals) and by simulated distillation (ASTM D7169).

The HDS rate is defined as follows:

HDS (%)=((% pds S)_{feed}−(% pds S)ᵣₑₜᵤᵣₙ)/(% pds S)_{feed}×100

Similarly, the HDM rate is defined as follows:

HDM (%)=((ppm pds Ni+V)_{feed}−(ppm pds Ni+V)ᵣₑₜᵤᵣₙ)/(ppm pds Ni+V)_{feed}×100

Finally, the conversion rate of the fraction 540° C.+ is defined by the following relation:

HDX₅₄₀₊(%)=((X₅₄₀₊)_{feed}−(X₅₄₀₊)_{effluent})/(X₅₄₀₊)_{feed}×100

The catalyst performance is summarised in Table 15. We clearly show that commixing according to the invention (C1 and D1 catalysts), in addition to reducing catalyst manufacturing costs, we observe overall performance at least as good as catalysts commixed from boehmite (catalyst D3), and better results than hydrotreating vacuum residue (VR) and the proportion of sediments formed. In the following, the results are presented by positioning the comparative catalyst to 100. The rates of hydrodesulphurisation HDS, hydrodemetalation HDM, conversion and sediments are then placed relative to this 100 reference level.

TABLE 15
HDS and HDM performances of the catalyst according to the invention
(C1, D1) and comparison with non-compliant D3 catalysts.

| | | | | Sediments |
|---|---|---|---|---|
| | HDS | HDM | HDX₅₄₀₊ | formed |
| Catalysts | (%) | (%) | (%) | (%/G5) |
| C1 (according to the | 104 | 98 | 98 | 92 |
| invention) | | | | |
| D1 (according to the | 102 | 97 | 99 | 95 |
| invention) | | | | |
| D3 (comparative) | 100 | 100 | 100 | 100 |

1. Procedure for preparing an active phase commixing catalyst, comprising at least one metal from the periodic table group VI B, possibly at least one metal from group VIII of the periodic table, possibly phosphorus and a predominantly aluminium calcined matrix oxide, comprising the following steps:
a) a step dissolving in water an acid aluminium precursor chosen from among aluminium sulphate, aluminium chloride and aluminium nitrate at a temperature between 20 and 90° C., a pH between 0.5 and 5, for a period between 2 and 60 minutes;
b) a step for adjusting the pH by adding into the suspension obtained in step a) at least one base precursor chosen from among sodium aluminate, potassium aluminate, ammonia, sodium hydroxide, or potassium hydroxide, at a temperature between 20 and 90° C., with a pH between 7 and 10, between 5 and 30 minutes.
(c) a step for co-precipitation of the suspension obtained after step b) by adding into the suspension at least one base precursor chosen between sodium aluminate, potassium aluminate, ammonia, sodium hydroxide or potassium hydroxide and at least one acid precursor selected from aluminium sulphate, aluminium chloride, aluminium nitrate, sulphuric acid, hydrochloric acid or nitric acid, at least one base or acid precursor comprising aluminium; the relative flow rate of the acidic and base precursors is chosen so as to obtain a pH of the reaction medium between 7 and 10 and the flow rate of the acidic and base precursors comprising aluminium is set so as to obtain a final alumina concentration in the suspension of between 10 and 38 g/l;
d) a step for filtering the suspension obtained after step c) co-precipitation to obtain alumina gel;
e) a step for drying the alumina gel obtained in step d) to obtain a powder;
f) a step for heat treating the powder resulting from step e) at a temperature between 500 and 1000° C., for between 2 and 10 hrs in the presence or not of an air flow containing up to 60% water volume to obtain an aluminium calcined pore oxide;
g) a step of mixing the aluminium calcined pore oxide obtained with a solution containing at least a metal precursor of the active phase to form a paste;
h) a step for shaping the obtained paste;
(i) a step for drying the shaped paste at a temperature less than or equal to 200° C. to obtain a dried catalyst;
(j) a possible step for heat treating the catalyst dried at a temperature between 200 and 1000° C. with or without water.

2. Process according to claim 1, in which the alumina concentration of the alumina gel suspension obtained in step c) is between 13 and 35 g/l.

3. Process according to claim 2, in which the alumina concentration of the alumina gel suspension obtained in step c) is between 15 and 33 g/l.

4. Process according claim 1, in which the acid precursor is selected among aluminium sulphate, aluminium chloride and aluminium nitrate.

5. Process according to claim 1, in which the base precursor is selected from sodium aluminate and potassium aluminate.

6. Process according claim 1 wherein, in steps a), b), and c) the aqueous reaction medium is water and the said steps are carried out while stirring, in the absence of an organic additive.

7. The hydroconversion catalyst with a bimodal pore structure comprising:
an oxide matrix predominantly of calcined aluminium;
a hydro-dehydrogenative active phase comprising at least one group VIB metal in the periodic table, possibly at least one group VIII metal in the periodic table, and possibly phosphorus; said active phase being at least partly commixed within the said oxide matrix mainly made up of calcined aluminium,
said catalyst having an S_{BET} specific surface greater than 100 m²/g, a mesoporous median diameter in volume between 12 and 25 nm inclusive, a macroporous median diameter in volume between 250 and 1500 nm inclusive, a mesoporous volume as measured by mercury intrusion porosimeter greater than or equal to 0.55 ml/g and a total measured pore volume by mercury porosimetry greater than or equal to 0.70 ml/g.

8. Hydroconversion catalyst according to claim 7, having a mesoporous median diameter in volume determined by intrusion using the mercury porosimeter between 13 and 17 nm inclusive.

9. Hydroconversion catalyst according to claim 7, having a macroporous volume between 10 and 40% of the total pore volume.

10. Hydroconversion catalyst according to claim 7, in which the mesoporous volume is greater than 0.70 ml/g.

11. Hydroconversion catalyst according claim 7, having no micropores.

12. Hydroconversion catalyst according to claim 7, wherein the metal content of group VI B is between 2 and 10% by weight of trioxide from the VI B group metal compared to the total mass of the catalyst; group VIII metal content is between 0.0 and 3.6% by weight of oxide from group VIII metal compared to the total mass of the catalyst; the amount of phosphorus content is between 0 and 5% by weight of phosphorus pentoxide compared to the total mass of the catalyst.

13. Hydroconversion catalyst according to claim 1, wherein the hydro-dehydrogenative active phase consists of molybdenum or nickel and molybdenum or cobalt and molybdenum.

14. Hydroconversion catalyst according to claim 13, in which the hydro-dehydrogenative active phase also includes phosphorus.

15. Process of hydroprocessing heavy hydrocarbon feeds selected from atmospheric residue, vacuum residues from direct distillation, deasphalted oils, residues from conversion processes from fixed bed, ebullated bed, or mobile bed hydroconversion, taken alone or in a mixture involving putting in contact the said feeds with hydrogen and with a catalyst claim 7.

16. A hydrotreating process according to claim 15, partly carried out in an ebullated bed at a temperature between 320 and 450° C., under a partial hydrogen pressure between 3 MPa and 30 MPa, at space velocity between 0.1 and 10 volumes of feed by catalyst volume per hour, and with a gaseous hydrogen ratio for liquid hydrocarbon feeds between 100 and 3000 normal cubic metres by cubic metres.

17. A hydrotreating process according to claim 15, at least partly carried out in a fixed bed at a temperature between 320 and 450° C., under a partial hydrogen pressure between 3 MPa and 30 MPa, at space velocity between 0.05 and 5 volumes of feed by catalyst volume per hour, and with a gaseous hydrogen ratio for liquid hydrocarbon feeds between 200 and 5000 normal cubic metres by cubic metres.

18. Process for hydrotreating heavy hydrocarbon residue type feeds in fixed bed according to claim 17, including at least:
(a) a hydrodemetalation step;
(b) a hydrodesulphurisation step;
in which the catalyst is used in at least one of the a) and b) steps.
